(19) United States
(12) Patent Application Publication
(10) Pub. No.: US 2014/0271406 A1
(43) Pub. Date: Sep. 18, 2014

(54) FLUID EJECTION DEVICE

(71) Applicant: SAMSUNG ELECTRO-MECHANICS CO., LTD., Suwon (KR)

(72) Inventors: Sang Youl JEON, Gyunggi-do (KR); Bo Sung KU, Gyunggi-do (KR)

(21) Appl. No.: 13/912,810

(22) Filed: Jun. 7, 2013

(30) Foreign Application Priority Data
Mar. 14, 2013 (KR) 10-2013-0027148

(51) Int. Cl. G01N 35/10

(52) U.S. Cl. CPC G01N 35/1016
USPC 422/521

(57) ABSTRACT

There is provided a fluid ejection device including a solenoid valve head ejecting a droplet, a fluid collection part collecting the droplet ejected from the solenoid valve head, a unit measuring a volume of the droplet collected in the fluid collection part, and a transfer unit transferring the fluid collection part.

### CROSS-REFERENCE TO RELATED APPLICATIONS

This application claims the priority of Korean Patent Application No. 10-2013-0027148 filed on Mar. 14, 2013, in the Korean Intellectual Property Office, the disclosure of which is incorporated herein by reference.

### BACKGROUND OF THE INVENTION

1. Field of the Invention

The present invention relates to a fluid ejection device, and more particularly, to a fluid ejection device enabling various volumes of fluid to be ejected using a single device.

2. Description of the Related Art

In conducting research using a biochip, the quantitative supply of fluid, such as a culture medium or a reagent, to the biochip is a very important factor in determining accuracy of test results.

An issue of quantitatively supplying fluid is more important in a cell chip required to be subjected to a toxicity test, an anti-cancer agent sensitivity test, or a resistance test in order to develop a new drug.

According to the related art, in supplying the fluid such as the culture medium or the reagent to the biochip, a fluid ejection device including a ceramic nozzle connected to a pump unit by a tube has mainly been used.

This fluid ejection device has had a limitation, in that since a minimum droplet amount supplied through the ceramic nozzle is on the level of several tens of μl even in the case in which an amount of ejected fluid is controlled using an electronic control, it may be difficult to quantitatively supply fluid and to supply the fluid in a micro amount.

In order to solve the limitation as described above, an ejection device capable of ejecting a droplet on the level of a few nl or less, according to an electronic control has been developed.

However, the ejection device capable of supplying a droplet on the level of a few nl or less may also not be able to adjust a volume of ejected fluid and the ejection device may disadvantageously need to be changed according to the amount of the ejected fluid. That is, there may be a defect in that a separate fluid ejection device needs to be purchased or provided, according to desired amounts of fluid to be ejected.

In addition, since it may be required to alternately using the fluid ejection device according to the volume of the ejected fluid, time consumed in exchanging or manipulating a test device may be increased and test accuracy may be degraded due to a decrease in the concentration of an experimenter.

In addition, in the case in which a type of fluid ejected from a single fluid ejection device is changed, ejection conditions need to be reset.

Meanwhile, there is provided Patent Document 1, the related art document associated with the present invention.

### RELATED ART DOCUMENT

(Patent Document 1) KR2010-0124764

### SUMMARY OF THE INVENTION

An aspect of the present invention provides a fluid ejection device capable of improving accuracy in quantitatively supplying fluid.

According to an aspect of the present invention, there is provided a fluid ejection device, including: a solenoid valve head ejecting a droplet; a fluid collection part collecting the droplet ejected from the solenoid valve head; a unit measuring a volume of the droplet collected in the fluid collection part; and a transfer unit transferring the fluid collection part.

The fluid collection part may be formed to have a rod shape extended in a single direction.

The fluid collection part may have a plurality of protrusions formed thereon, the protrusions preventing the collected droplet from being separated from the fluid collection part.

The protrusions may be disposed in a zigzag form in a length direction of the fluid collection part.

The fluid collection part may have a hydrophobic water-repellent coating surface.

The fluid ejection device may further include an environmental control part controlling temperature and humidity surrounding the fluid collection part.

According to another aspect of the present invention, there is provided a fluid ejection device, including: a solenoid valve head ejecting a droplet; a fluid collection part collecting the droplet ejected from the solenoid valve head; a unit measuring a volume of the droplet collected in the fluid collection part; and a transfer part transferring the solenoid valve head and the unit.

The fluid collection part may be formed to have a rod shape extended in a single direction.

The fluid collection part may have a plurality of protrusions formed thereon, the protrusions preventing the collected droplet from being separated from the fluid collection part.

The protrusions may be disposed in a zigzag form in a length direction of the fluid collection part.

The fluid collection part may have a hydrophobic water-repellent coating surface.

The fluid ejection device may further include an environmental control part controlling temperature and humidity surrounding the fluid collection part.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a fluid ejection device according to an embodiment of the present invention;

FIG. 2 is a front view of the fluid ejection device according to the embodiment of the present invention;

FIG. 3 is an enlarged view of part A of FIG. 2 illustrating a state after a solenoid valve head moves to a position corresponding to a fluid collection part;

FIG. 4 is a conceptual view illustrating the fluid ejection device according to the embodiment of the present invention;

FIG. 5 is a view showing a shape of a first fluid imaged by a unit of FIG. 1;

FIG. 6A is a view showing a shape of a second fluid imaged by the unit of FIG. 1;

FIG. 6B is a view showing a shape of a second fluid of the fluid collection part imaged by the unit of FIG. 1; and

FIGS. 7 and 8 are perspective views respectively illustrating a fluid collection part included in the fluid ejection device according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

FIG. 1 is a perspective view of a fluid ejection device according to an embodiment of the present invention. FIG. 2 is a front view of the fluid ejection device according to the embodiment of the present invention. FIG. 3 is an enlarged view of part A of FIG. 2 illustrating a state after a solenoid valve head moves to a position corresponding to a fluid collection part. FIGS. 7 and 8 are perspective views respectively illustrating a fluid collection part included in the fluid ejection device according to the embodiment of the present invention.

Referring to FIGS. 1 through 3, a fluid ejection device 10 according to an embodiment of the present invention may include a piezo pipette head 100, a solenoid valve head 200, and a fluid collection part 300.

The piezo pipette head 100 may be a component for ejecting a first fluid 110 (see FIG. 4) having a relatively smaller volume than that of a second fluid 210 ejected from the solenoid valve head 200.

That is, the piezo pipette head 100 may eject the first fluid 110 using a piezo pipette and may be supplied with the first fluid 110 by a pump 400 to be described below.

That is, the pump 400 may aspirate the first fluid 110.

Here, the first fluid 110, ejected from the piezo pipette head 100, is imaged by a unit 500, such that a volume of the ejected first fluid 110 may be accurately measured.

That is, since the first fluid 110 ejected from the piezo pipette head 100 has a very small volume, it may be ejected in a significantly small spherical shape immediately after the first fluid 110 is ejected, unlike the second fluid 210 ejected from the solenoid valve head 200.

Therefore, in the case in which the first fluid 110 is imaged by the unit 500, accurate volume measurements thereof may be possible due to the spherical shape of the first fluid 110. For reference, the unit 500 may be a device capable of measuring a volume of an object, such as an imaging apparatus and a volume measuring apparatus.

Here, the unit 500 may move in a vertical direction and a position thereof may be changed automatically or manually so as to match a position of the first fluid 110 ejected from the piezo pipette head 100.

In this case, the unit 500 may set an image test region 510 (see FIG. 5) corresponding to the first fluid 110 in order to accurately measure a volume of the first fluid 110 in droplet form. Moreover, the unit 500 may calculate the volume of the first fluid 110 through the image of the first fluid 110 disposed in the image test region 510.

Meanwhile, in the case in which the volume of the first fluid 110 measured by the unit 500 is outside of a preset numerical range, the amount of the first fluid 110 ejected from the piezo pipette head 100 may be adjusted by adjusting a voltage applied to the piezo pipette head 100 or a voltage application time.

Here, a series of processes as above described may be controlled by a setting control part (not shown). For reference, the setting control part may be mounted on any location of the fluid ejection device 10. For example, the setting control part may be integrally mounted on a transfer part 700.

The piezo pipette head 100 may be movable to enable the first fluid 110 to be ejected to a biochip 600. To this end, the piezo pipette head 100 may be mounted on the transfer part 700. Here, the transfer part 700 may be mounted on a rail part 800 and may move in a length direction of the rail part 800.

The solenoid valve head 200 may be a component for ejecting the second fluid 210 having a volume relatively larger than that of the first fluid 110 ejected from the piezo pipette head 100. Here, the second fluid 210 may be supplied to the solenoid valve head 200 by the pump 400.

The solenoid valve head 200 may be coupled to the piezo pipette head 100 through a connection part 150. Therefore, the solenoid valve head 200 and the piezo pipette head 100 may be transferred together in the same direction by the transfer part 700. That is, the solenoid valve head 200 and the piezo pipette head 100 may be coupled to the transfer part 700 together, and may move in a direction as the transfer part 700 moves along the rail part 800.

However, the solenoid valve head 200 may be coupled to another transfer part (not shown) as needed, such that it may also move independently from the piezo pipette head 100.

The solenoid valve head 200 may eject a fluid having a water stream shape rather than the droplet form. That is, the second fluid 210 ejected from the solenoid valve head 200 may have another shape, rather than the spherical shape. For this reason, it may be difficult to accurately measure the volume of the second fluid 210 ejected from the solenoid valve head 200 through the unit 500.

A detailed description thereof will be provided below with reference to FIGS. 4 through 6B. Here, a method of measuring the volume of the second fluid 210 will be first described.

The fluid collection part 300, a component for measuring the volume of the second fluid 210 ejected from the solenoid valve head 200, may allow the second fluid 210 to be collected on one surface of the fluid collection part 300.

That is, the fluid collection part 300 may enable the unit 500 to measure the volume of the second fluid 210 ejected from the solenoid valve head 200 before the second fluid 210 ejected from the solenoid valve head 200 is transferred to the biochip 600 or the like, such that accuracy in quantitatively supplying the fluid to the biochip 600 or the like may be improved.

In other words, in order to accurately measure the volume of the fluid with the unit 500, the fluid to be measured needs to have a spherical shape, but the second fluid 210 ejected from the solenoid valve head 200 forms a long water stream shape rather than the spherical shape.

Therefore, an element for forming the second fluid 210 ejected from the solenoid valve head 200 to have the spherical shape is required. In embodiment of the present invention, this is implemented by the fluid collection part 300.

The fluid collection part 300 may have a hydrophobic water-repellent coating surface provided on an upper surface thereof. Therefore, in the case in which the second fluid 210 is collected on the fluid collection part 300, the second fluid 210 may stably form a spherical shape.

Therefore, the second fluid 210 formed to have a spherical shape on the fluid collection part 300 including the water repellent coating surface may be imaged by the unit 500, such that the volume of the second fluid 210 ejected from the solenoid valve head 200 may be accurately measured.

The fluid collection part 300 may be formed to have a rod shape extended in a single direction as shown in FIG. 7. The shape of the fluid collection part 300 may be advantageous to continuously eject a plurality of droplets to the fluid collection part 300. That is, since the rod shaped fluid collection part 300 may have a size capable of collecting the plurality of droplets thereon, new droplets may be continuously collected on the rod shaped fluid collection part 300 without separately performing a process of cleaning a surface of the fluid collection part 300.

The fluid collection part 300 may move in a single direction (a length direction of the rail part 800 based on FIG. 1) in a body 900. To this end, a transfer unit 910 may be mounted in the body 900 to transfer the fluid collection part 300. Here, the transfer unit 910 may include a rail and a linear motor moving along the rail.

Meanwhile, the fluid collection part 300 may have a plurality of protrusions 310 formed on a surface thereof as shown in FIG. 8. The plurality of protrusions 310 may prevent the droplets previously collected in the movement process of the fluid collection part 300 from being separated from the fluid collection part 300 or from being transferred to another portion.

The unit 500 may set an image test region 520 (see FIG. 6B) corresponding to the second fluid 210 in order to accurately measure the volume of the first fluid 210. Moreover, the unit 500 may calculate the volume of the second fluid 210 through the image of the second fluid 210 disposed in the image test region 520.

In the case in which the volume of the second fluid 210 measured by the unit 500 is outside of the preset numerical range, the amount of the second fluid 210 ejected from the solenoid valve head 200 may be adjusted by adjusting a valve opening time applied to the solenoid valve head 200.

The series of processes as described above may be controlled by the setting control part (not shown), and the setting control part (not shown) may be disposed at any position of the fluid ejection device according to the embodiment of the present invention.

Meanwhile, although not shown in FIG. 1, an air blower may be disposed to be adjacent to the fluid collection part 300. Here, the air blower may rapidly clean and dry the surface of the fluid collection part 300 by spraying compressed air on the fluid collection part 300 at high speeds.

The fluid ejection device 10 according to the embodiment of the present invention may include the body 900 configuring the exterior thereof. Here, in the body 900, components such as the piezo pipette head 100, the solenoid valve head 200, the fluid collection part 300, and the like described above may be mounted.

In addition, the body 900 may include a plurality of legs respectively capable of adjusting heights thereof and the body 900 may be maintained in a horizontal state by providing the plurality of legs.

Moreover, the body 900 may be provided with a storage space in which separate devices may be installed, and may include wheels to facilitate movements of the body 900.

In addition, the fluid ejection device 10 according to the embodiment of the present invention may further include an environmental control part 940 and a cover 920.

Here, the biochip 600 provided in the body 900 may include a biological tissue and may significantly sensitive to surrounding environments (particularly, temperature and humidity).

For example, the biochip 600 including the biological tissue may be easily dried or deformed in dried environments.

Therefore, the fluid ejection device 10 according to the embodiment of the present invention may include the environmental control part 940 in consideration of the above-mentioned facts and may further include the cover 920 for protecting the biochip 600 from an external environment.

The environmental control part 940 may automatically or manually control temperature and humidity in an inner space of the body part 900, that is, of the surrounding environments of the piezo pipette head 100 and the solenoid valve head 200.

The environmental control part 940 may have a discharge outlet 945 protruded to the inner space of the body 900 and air such as cold and hot air may be supplied through the discharge outlet 945. In addition, the environmental control part 940 may maintain the biochip 600 in environments required to preserve the biochip 600 for several hours, by supplying a predetermined water vapor through the discharge outlet 945 and adjusting the humidity.

FIG. 4 is a conceptual view illustrating the fluid ejection device according to the embodiment of the present invention. FIG. 5 is a view showing a shape of a first fluid imaged by a unit of FIG. 1. FIG. 6A is a view showing a shape of a second fluid imaged by the unit of FIG. 1. FIG. 6B is a view showing a shape of a second fluid of the fluid collection part imaged by the unit of FIG. 1.

Referring to FIGS. 4 through 6B, the fluid ejection device 10 according to the embodiment of the present invention may include the piezo pipette head 100 and the solenoid valve head 200 for ejecting fluid having various volumes.

Since the first fluid 110 ejected from the piezo pipette head 100 may have a significantly small volume, the volume of the first fluid 110 may be accurately measured by imaging the first fluid 110 immediately after being ejected by the unit 500.

That is, since the first fluid 110 ejected from the piezo pipette head 100 forms a significantly small spherical shape as shown in FIG. 5, the volume thereof may be accurately measured because of the spherical shape in the case of imaging the first fluid 110 by the unit 500.

In this case, the unit 500 may set the image test region 510 corresponding to the first fluid 110 in order to accurately measure the volume of the first fluid 110 and the volume may be easily calculated by the image of the first fluid 110 disposed in the image test region 510.

In addition, in the case in which a numerical range of the volume of the first fluid 110 measured by the unit 500 is outside of a preset numerical range, the setting control part (not shown) may adjust a voltage applied to the piezo pipette head 100 or a voltage application time, such that the amount of the first fluid 110 ejected from the piezo pipette head 100 may be adjusted. This description is the same as the above-mentioned description.

Meanwhile, since the second fluid 210 ejected from the solenoid valve head 200 has a relatively large volume than that of the first fluid 110 ejected from the piezo pipette head 100, the second fluid 210 ejected from the solenoid valve head 200 forms a long water stream shape, rather than a spherical shape, as shown in FIG. 6A.

Therefore, it is difficult to measure the second fluid 210 immediately after being ejected from the solenoid valve head 200, using the unit 500, due to characteristics of the second fluid 210 as described above.

That is, in order to measure the volume of the imaged fluid using the unit 500, the fluid needs to have a spherical shape, in the image thereof.

However, since the second fluid 210 immediately after being ejected from the solenoid valve head 200 does not have a spherical shape as shown in FIG. 6A, a separate measuring unit is required in order to accurately measure the volume of the second fluid 210.

Therefore, the second fluid 210 ejected from the solenoid valve head 200 may be collected on one surface of the fluid collection part 300 and may have a spherical shape, and the second fluid 210 in this state is imaged by the unit 500, such that the volume of the second fluid 210 may be measured.

Here, as shown in FIG. 6B, when the second fluid 210 is formed on one surface of the fluid collection part 300 having the water repellent coating surface, the unit 500 may accurately measure the volume of the second fluid 210 through the image of the second fluid 210 by setting the image test region 520 corresponding to the second fluid 210.

Meanwhile, in the case in which a numerical value of the volume of the second fluid 210 measured by the unit 500 is outside of a preset numerical range, the setting control part (not shown) may adjust the valve open time applied to the solenoid valve head 200, such that the amount of the second fluid 210 ejected from the solenoid valve head 200 may be adjusted. This description is the same as the above-mentioned description.

According to the embodiments as described above, since the fluid ejection device 10 includes the piezo pipette head 100 and the solenoid valve head 200, various volumes of fluid may be ejected from a single device.

In addition, before the first fluid 110 or the second fluid 210 ejected from the piezo pipette head 100 or the solenoid valve head 200 is substantially ejected to the biochip 600 including a biological tissue, the volume of the ejected fluid may be accurately measured in advance using the unit 500 and the fluid collection part 300.

Therefore, accuracy in quantitatively supplying the ejected fluid to the biochip 600 is improved by accurately measuring the volume of the ejected fluid, such that accuracy in experimentation may be significantly increased.

In addition, even in the case that the type of ejected fluid is changed, since a volume of the fluid is simply measured before the fluid is ejected to the biochip 600, the setup does not need to be reset, such that the time required to prepare an experiment may be decreased.

Further, an accurate experimental result may be implemented by detecting setup errors of an experimenter in advance before performing the experiment.

Meanwhile, in the descriptions and the accompanying drawings in connection with the above described embodiments, the case in which the fluid ejection device 10 includes both of the piezo pipette head 100 and the solenoid valve head 200. However, the piezo pipette head 100 may be omitted as needed. That is, the fluid ejection device 10 according to another embodiment of the present invention may include the solenoid valve head 200, the fluid collection part 300, and the unit 500.

Asset forth above, according to a fluid ejection device, various volumes of fluid may be ejected from a single device.

In addition, the volume of the ejected fluid may be accurately measured before the fluid is substantially ejected to a biochip, and the like, and in the case in which the measured volume of the fluid is different from a preset volume, the difference therebetween may be corrected.

In addition, even in the case that the type of ejected fluid is changed, the setup does not need to be reset, such that the time required for preparing an experiment may be decreased.

Further, accurate experiment results may be implemented by detecting setup errors of an experimenter in advance before performing the experiment.

While the present invention has been shown and described in connection with the embodiments, it will be apparent to those skilled in the art that modifications and variations can be made without departing from the spirit and scope of the invention as defined by the appended claims.

What is claimed is:

1. A fluid ejection device, comprising:
a solenoid valve head ejecting a droplet;
a fluid collection part collecting the droplet ejected from the solenoid valve head;
a unit measuring a volume of the droplet collected in the fluid collection part; and
a transfer unit transferring the fluid collection part.

2. The fluid ejection device of claim 1, wherein the fluid collection part is formed to have a rod shape extended in a single direction.

3. The fluid ejection device of claim 1, wherein the fluid collection part has a plurality of protrusions formed thereon, the protrusions preventing the collected droplet from being separated from the fluid collection part.

4. The fluid ejection device of claim 3, wherein the protrusions are disposed in a zigzag form in a length direction of the fluid collection part.

5. The fluid ejection device of claim 1, wherein the fluid collection part has a hydrophobic water-repellent coating surface.

6. The fluid ejection device of claim 1, further comprising an environmental control part controlling temperature and humidity surrounding the fluid collection part.

7. A fluid ejection device, comprising:
a solenoid valve head ejecting a droplet;
a fluid collection part collecting the droplet ejected from the solenoid valve head;
a unit measuring a volume of the droplet collected in the fluid collection part; and
a transfer part transferring the solenoid valve head and the unit.

8. The fluid ejection device of claim 7, wherein the fluid collection part is formed to have a rod shape extended in a single direction.

9. The fluid ejection device of claim 7, wherein the fluid collection part has a plurality of protrusions formed thereon, the protrusions preventing the collected droplet from being separated from the fluid collection part.

10. The fluid ejection device of claim 9, wherein the protrusions are disposed in a zigzag form in a length direction of the fluid collection part.

11. The fluid ejection device of claim 7, wherein the fluid collection part has a hydrophobic water-repellent coating surface.

12. The fluid ejection device of claim 7, further comprising an environmental control part controlling temperature and humidity surrounding the fluid collection part.
